(19) United States
(12) Patent Application Publication
(10) Pub. No.: US 2006/0031325 A1
(43) Pub. Date: Feb. 9, 2006

(54) Method for managing email with analyzing mail behavior

(76) Inventor: Chih-Wen Cheng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/880,741

(22) Filed: Jul. 1, 2004

(51) Int. Cl. G06F 15/16

(52) U.S. Cl. 709/206

(57) ABSTRACT

The present invention discloses a method for managing email with analyzing the mail behavior. The method utilizes the mail policies, such as the envelope information and the header information, to verify the transmission data one by one while the agent receives the email. Then, the method performs a corresponding action in accordance with the verified result. When the mail policy is defined as behavior of the spam, the email will be blocked while matched; and when the mail policy is defined as the exempted mail, the email will be delivered while matched. The present invention can achieve the purpose of managing the email communication and blocking the spam, and can improve the communication efficiency and reduce the operation cost.

### BACKGROUND OF INVENTION

1. Field of the Invention

The invention relates to a method for managing email, and more particularly, to a method for managing email with analyzing the mail behavior.

2. Description of the Prior Art

The virus, hackers and spam are serious problems to the email information security in a business. Most mail filtering, virus scanning and spam blocking software companies utilize a huge database to process and analyze emails, and collect a large number of “mail contents” for numerically analysis to achieve the spam blocking function. The conventional method also has some subjective disadvantages of erroneous judgments, such as pornographies, wealth, drugs and commerce, and the email filter may also cause the system resource consumption and the communication efficiency reduction.

The international common consensus divides the spam into the trash mails and the advertisement mails, and the difference should be distinguished before discussing the spam blocking. In the United States, the trash mail in the Can-Spam law means that sending email with the behaviors of anonymity, counterfeit, misuse or illegality (varying or hiding information), and the tricks may be: 1. The source cannot be traced; 2. The communication method is varied; 3. Make the receiver misconstruing as colleague or friend; and 4. Make the receiver curious to read mail. The trash mails have unidentifiable source or cannot be successfully rejected, so a special technology is needed to block them. The advertisement mail means that the sender gets the receiver's email address via a specific way, and sends email with a normal method. The receiver can trace the email source and cancel it.

The conventional spam blocking technology can be divided into three methods: filtering the contents, calculating the numerical value and enlightenment. The method of filtering the contents is providing a blocking list containing sender, receiver, mail header, mail contents, extension name, file name and file contents in advance to block the spam, and the disadvantages are that the list is difficult to collect, the list is time-consuming to build, the blocking rate is too low, and erroneous judgment. The method of calculating the numerical value utilizes a huge database to calculate and analyze. With collecting many “mail contents” of the spam and calculating the numerical value, the spam can be blocked, and the disadvantages are subjective judgment (such as pornographies, wealth, drugs and commerce), no decision, erroneous judgment, system resource consumption, and communication efficiency reduction. The method of enlightenment technology is similar to that of calculating the numerical value, which also utilizes a huge database to calculate and analyze many “mail contents” of the spam. Besides calculating the numerical value, an intellectual enlightenment method is also used, so the disadvantages include what the method of calculating the numerical value has, and that more the erroneous judgment while larger the database.

Hence, the present invention discloses a method for managing email with analyzing the mail behavior to overcome these disadvantages.

### SUMMARY OF INVENTION

It is therefore a primary objective of the claimed invention to provide a method for managing email with analyzing the mail behavior to achieve the purpose of managing email communication.

It is therefore another objective of the claimed invention to provide a method for managing email with analyzing the mail behavior to effectively block the spam.

It is therefore a further objective of the claimed invention to provide a method for managing email with analyzing the mail behavior to accurately manage the email, and have the advantages of saving the network bandwidth, system resource and hard disk space to give consideration to both the network security and the communication efficiency.

It is therefore a further objective of the claimed invention to provide a method for managing email with analyzing the mail behavior to save the operation cost.

According to the claimed invention, a method for managing an email with analyzing a mail behavior comprising steps of: defining a plurality of different mail policies with an envelope information and a header information; and comparing a mail transmission data of the email with the mail policies one by one when an agent receives the email to determine whether behavior of the email matches the mail policy, and performing a corresponding blocking/transmitting action in accordance with comparing result.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of the method for managing an email with analyzing a mail behavior according to the present invention;

FIG. 2 is a flow chart of verifying email with the rules of a mail policy according to the present invention; and

FIG. 3 is a flowchart of verifying email with a predetermined mail policy according to the present invention.
10 mail policy
12 rule

### DETAILED DESCRIPTION

The present invention verifies the true and false value of the transmission data of an email with a predetermined mail policy in the executing step of the mail transfer agent (MTA). With analyzing the transmission data of mail envelope and mail header, the method can determine whether the email matches the allowance behaviors, and achieve the purpose of controlling email communication and blocking the spam.

A complete email is called a mail text. Generally, the mail text includes the mail envelope, the mail header and the mail content. The basic transmission mode of a complete email has the process procedure of a mail transfer agent (MTA) and a mail user agent (MUA) between the server and the user. The present invention utilizes this characteristic and principle to analyze and verify the true and false value of transmission data, such as mail envelope and mail header, and concludes hundreds of mail behaviors to manage the mail communication and block the spam.

Since the present invention uses the envelope information of an email to define the mail policy, the content of the envelope information should be explain in advance. Generally, the envelope information includes sender address, receiver address, sender host address, receiver host address, reply address, domain name server (DNS) and e-postmark, wherein the e-postmark added when passing through each of the sender server, central-office server and ISP server.

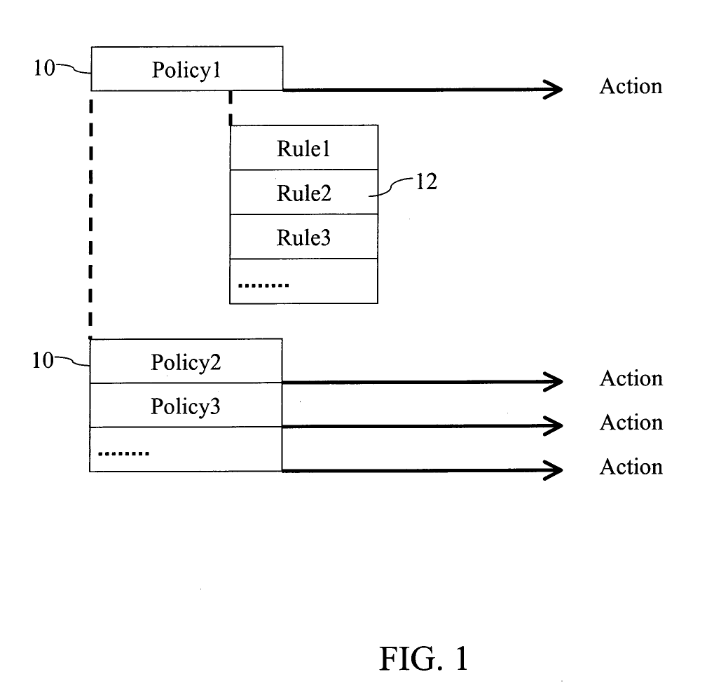

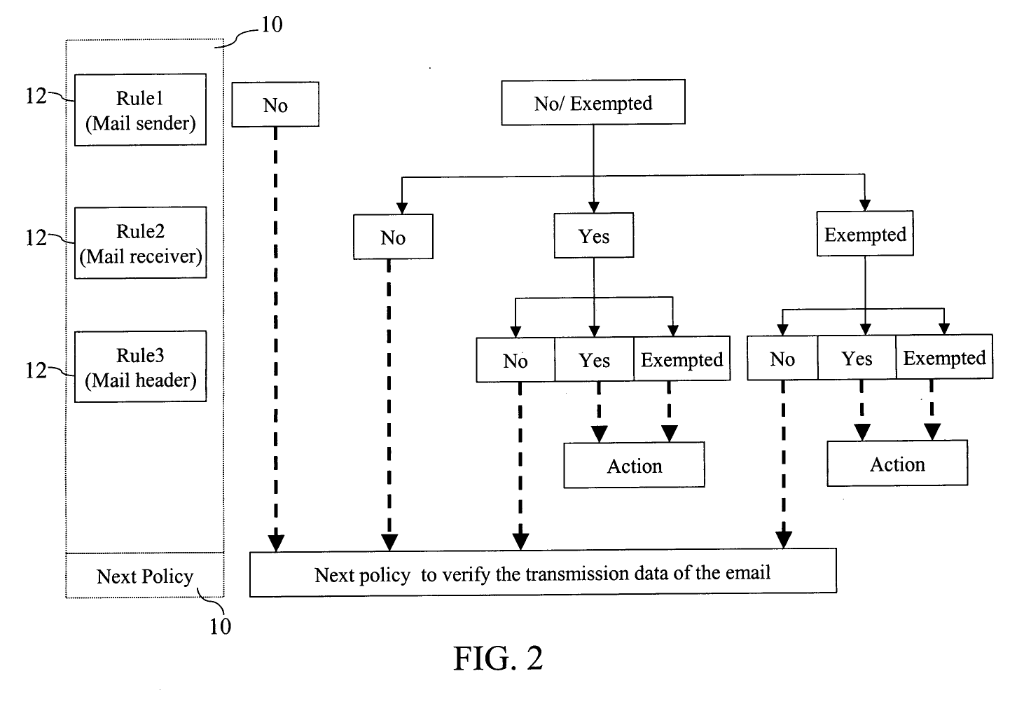

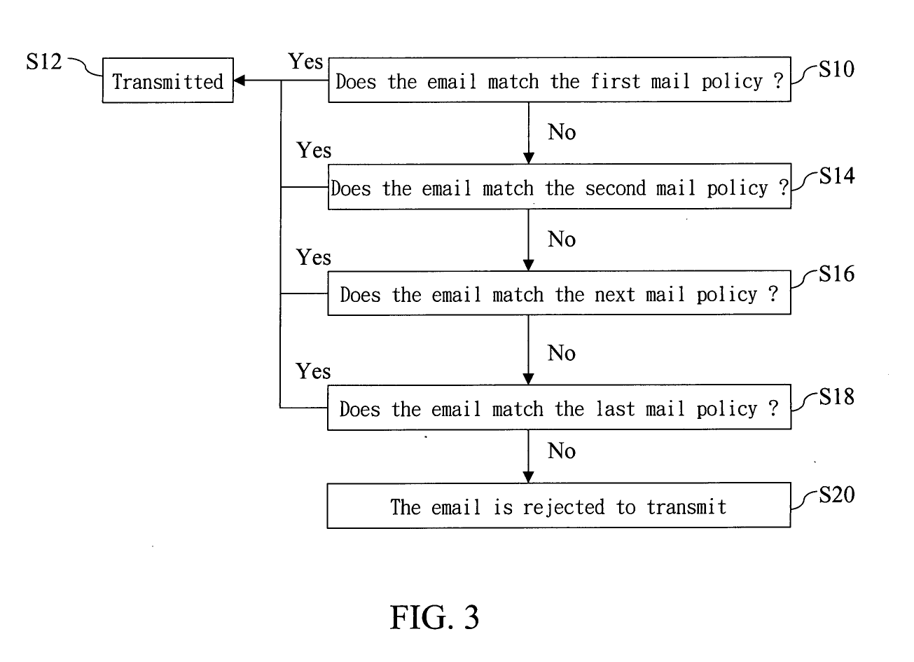

FIG. 1 is a schematic diagram of the method for managing an email with analyzing a mail behavior according to the present invention. The method includes steps of: firstly, defining a plurality of different mail policies 10 with envelope information, header information, content and attachment, and each mail policy 10 includes a plurality of rules 12. FIG. 2 shows that the definition of each mail policy 10 includes three rules 12, the envelope sender, the envelope receiver and the mail header, and the system will execute only when the three rules 12 are all matched. With the definition of the rule 12, the user can designate one of the conditions matched, unmatched and ignored, and that also means the user can designate the envelope sender or the envelope receiver or undesignate for selecting all. The user can also select verifying or ignoring the mail header, and the relationship of all rules 12 are “AND” and the system will execute under the condition is hold when all matched. Similarly, when defining the mail policies 10, the user can designate one of conditions matched, unmatched and ignored.

After defining the mail policy 10 and the rule 12, the agent verifies the transmission data of an email with the mail policies 10 one by one when receiving the email. The transmission data includes the envelope information and the header information of the email, even the content or attachment, which is defined by the mail policies 10 and the rules 12 to verify whether the email behavior matches the mail policies 10. A corresponding transmitting or blocking action will be hold in accordance with the result of verification.

The user can define the mail policies 10 and the rules 12 for the behaviors of the spam or the exempted mail to verify the emails. When the mail policies 10 and the rules 12 are defined as the behaviors of the spam, the steps after the agent receives the emails are: comparing the transmission data of the email with the mail policies 10 one by one to determine whether behavior of the email matches the mail policies 10, if yes, that means the email is a spam and will be blocked; and if no, the email will be transmitted.

Oppositely, when the mail policies 10 and the rules 12 are defined as the exempted mail, the steps after the agent receives the emails are: comparing the mail transmission data of the email with the mail policies 10 one by one to determine whether behavior of the email matches the mail policies 10, if yes, that means the email is a exempted mail and will be transmitted; and if no, the email will be blocked. With the definition of the exempted mail, the exempted users can be defined. The sender of the exempted mails includes parent company, subsidiary company, important customer, supplier, domain name of e-paper and fixed IP. In addition, the permitted internal user can access the emails outside the business intranet (such as at home, supplier, or specific points), and the exempted user can have high priority.

The action of the agent is opposite based on the definition of the mail policies 10 that when the mail policy is defined as the behavior of the spam, the email will be blocked while matching, and when the mail policy is defined as the exempted mail, the email will be delivered while matching. The operation principles are similar, so the following embodiment only explains the management of the spam, and the exempted mail will be omitted.

Illustrating with the management of the spam, when verifying whether the email matches the mail policies 10, the detail procedures are shown in FIG. 3. When the agent receives the email, a first mail policy is used to verify the transmission data of the email and determine whether the email matches the first mail policy. If matched, the step S12 will be performed to allow the email to deliver; and if unmatched, the step S14 will be performed.

In the step S14, the agent continuously traces behavior of the email with the second policy to determine whether the email matches the second mail policy. If matched, the email will be allowed to deliver and the step S12 is performed; and if unmatched, the step S16 will be performed and trace behavior of the email with a next mail policy till a last mail policy is used. When the last mail policy is used, as shown in step S18, if the email matches this mail policy, the step S12 will be performed; and if unmatched, the email is confirmed having no allowance to transmit and the step S20 will be performed.

When the email is not allowed to transmit, the agent can reject receiving the email and send back an error code and error message, or directly delete the email. The action of not transmitting the email can be predetermined when defining the mail policy.

In addition, when verifying the transmission data of the email with one of the mail policies, the detail procedure of FIG. 3 can be explained with referring to FIG. 2 as follows:
(a) Firstly, performing a true and false verification to the transmission data of the email with a first rule to determine whether the email matches the first rule, if yes, the step (b) will be performed, and if no, the step (c) will be performed;
(b) Performing a true and false verification to the transmission data of the email with a second rule to determine whether the email matches the second rule, if no, the step (c) will be performed, and if yes, a next rule will be performed to trace behavior of the email till the last rule is used. Determining whether the email matches the mail policy in accordance with the result of verifying the last rule, if matched, the email is allowed to transmit, and if unmatched, the step (c) will be performed; and
(c) Continuously tracing the behavior of the email with the next mail policy to determine whether the email matches the mail policy, if matched, the email is allowed to transmit, and if unmatched, a next mail policy is used to trace the behavior of the email till the last mail policy is used.

Hence, the present invention manages the important information to control the email communication by correctly defining the email behavior and the processing procedure.

The spam is sent with the behaviors of anonymity, counterfeit, misuse or illegality (varying or hiding information) and cannot be traced or be canceled. If the sender can be verified painstakingly sending the email with the behaviors of anonymity, counterfeit, misuse or illegality (varying or hiding information), the sender can be identified to be a spam sender.

The above-mentioned mail policy can be a user to verify whether the email is a spam and determine abnormal behavior, such as anonymity, counterfeit, misuse or illegality. After verifying, if the email is abnormal, the email can be determined as a spam. For example, the behavior of anonymity may be that the header information is unclear, the sender and reply hosts are different, or the reply host is an ISP host. The behavior of counterfeit may be that the source host is an external one but counterfeiting as an internal one, or the DNS is incorrect. The behavior of misuse is that the delivering way abnormal and various. The behavior of illegality is that the reply host is a rental one.

With analyzing the behavior of anonymity, the present invention can verify the behaviors described above and can also verify the emails sent by machine, hacker or human, such as verifying the emails sent by a postmaster, a mailerdemon, or a listserver.

The present invention of managing email with analyzing the mail behavior is always performed in an agent, and the most used one is a MTA. When executing in the MTA, the email is verified with analyzing the true and false value of the transmission data by controlling the mail envelope and mail header with simulating the spam. The email can be correctly verified whether matches behavior of the spam, and the MTA can also be a router.

The method for managing the email with analyzing the mail behavior is explained above, and three examples are described below for explanation. People familiar in the art can bring into force accordingly.

### Example 1

### Controlling Email Communication—Specific Internal Users Can Only Send Emails to Specific Internal Users

| Start | Envelope information: the rule relationship is “AND”, and | | | | |
|---|---|---|---|---|---|
| | hold under all match. | | | | |
| [symbol] | Envelope | Item | with/ | Select address list | |
| | Sender | | without | | |
| | | Host | + | specific internal user | |
| [symbol] | Envelope | Item | with/ | Select address list | |
| | Receiver | | without | | |
| | | Host | − | specific internal user | |
| Mail header | | ◯ Verify ⊚ Ignore | | | |
| Start | Mail header: the rule relationship is “AND”, and hold | | | | |
| | under all match. | | | | |
| □ | Item | Condition | Method | with/ | Select address list |
| | | | | without | or fill by oneself |
| | Header | Element | Method | +/− | [symbol] |

| | |
|---|---|
| Match | ⊚ match ◯ Unmatch above policies, perform |
| condition | the following procedure. |
| Procedure | ⊚ Reject receiving, send back error code and |
| | error message. |
| | ◯ Delete mail, don't send back error code and |
| | error message. |
| | ◯ Directly deliver. |

### Example 2

### Blocking Spam—Illuminating with Anonymity, the Send and Reply Hosts are Different

| Start | Envelope information: the rule relationship is “AND”, and | | | | |
|---|---|---|---|---|---|
| | hold under all match. | | | | |
| □ | Envelope | Item | with/ | Select address list | |
| | Sender | | without | | |
| | | Envelop | +/− | [symbol] | |
| | | From | | | |
| □ | Envelope | Item | with/ | Select address list | |
| | Receiver | | without | | |
| | | Envelop | +/− | [symbol] | |
| | | To | | | |
| Mail header | | ⊚ Verify ◯ Ignore | | | |
| start | Mail header: the rule relationship is “AND”, and hold | | | | |
| | under all match. | | | | |
| [symbol] | Item | Condition | Method | with/ | Select address |
| | | | | without | list or fill by |
| | | | | | oneself |
| | From | Host | Cache | +/− | [symbol] |
| [symbol] | Item | Condition | Method | with/ | Select address |
| | | | | without | list or fill by |
| | | | | | oneself |
| | Return - | Host | Match | +/− | [symbol] |
| | Path | | Cache | | |

| | |
|---|---|
| Match condition | ◯ match ⊚ Unmatch above policies, |
| | perform the following procedure. |
| Procedure | ⊚ Reject receiving, send back error code and |
| | error message. |
| | ◯ Delete mail, don't send back error code and |
| | error message. |
| | ◯ Directly deliver. |

### Example 3

### Blocking Spam, Illuminating with Counterfeit, the Source Host is External and the Sender Address Counterfeit as Internal

| Start | Envelope information: the rule relationship is “AND”, and | | | | |
|---|---|---|---|---|---|
| | hold under all match. | | | | |
| □ | Envelope | Item | with/ | Select address list | |
| | Sender | | without | | |
| | | Envelop | +/− | [symbol] | |
| | | From | | | |
| □ | Envelope | Item | with/ | Select address list | |
| | Receiver | | without | | |
| | | Envelop | +/− | [symbol] | |
| | | To | | | |
| Mail header | | ⊚ Verify ◯ Ignore | | | |
| Start | Mail header: the rule relationship is “AND”, and hold | | | | |
| | under all match. | | | | |
| [symbol] | Item | Condition | Method | with/ | Select address list |
| | | | | without | or fill by oneself |
| | Sender | Sender | Domain | − | internal host |
| | | Host | | | |
| [symbol] | Item | Condition | Method | with/ | Select address list |
| | | | | without | or fill by oneself |
| | From | Sender | Domain | + | internal host |
| | | Host | | | |

| | |
|---|---|
| Match | ⊚ match ◯ Unmatch above policies, perform |
| condition | the following procedure. |
| Procedure | ⊚ Reject receiving, send back error code and |
| | error message. |
| | ◯ Delete mail, don't send back error code and |
| | error message. |
| | ◯ Directly deliver. |

In contrast to the prior art, the present invention utilizes the characteristic and principle of the email to analyze the mail envelope and the mail header to conclude whether the email is allowed to transmit so that the email communication and information security can be effectively managed. The present invention not only can accurately manage the emails and block the spam to ensure the network security but also can save the network bandwidth, system resource and hard disk space to improve the email communication efficiency and reduce the operation cost.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for managing an email with analyzing a mail behavior comprising steps of:
defining a plurality of different mail policies with an envelope information and a header information; and
comparing a mail transmission data of the email with the mail policies one by one when an agent receives the email to determine whether behavior of the email matches the mail policy, and performing a corresponding blocking/transmitting action in accordance with comparing result.

2. The method of claim 1, wherein the mail policies are used for determining whether the email is a spam, and the method of determining the email after the agent receives the email comprises steps of:
comparing the mail transmission data of the email with the mail policies one by one to determine whether behavior of the email matches the mail policy, if yes, that means the email is a spam and will be blocked; and
if no, the email will be transmitted.

3. The method of claim 1, wherein the mail policies are guard policies for defining behavior of exempted mails, and the method of determining the email after the agent receives the email comprises steps of:
comparing the mail transmission data of the email with the mail policies one by one to determine whether behavior of the email matches the mail policy, if yes, that means the email is a exempted mail and will be transmitted; and
if no, the email will be blocked.

4. The method of claim 3, wherein sender of the exempted mail includes parent company, subsidiary company, important customer, supplier, domain name of e-paper and at least one of groups composed of fixed IP.

5. The method of claim 1, wherein the step of defining the mail policies includes defining a verification criterion of each mail policy, the verification criterion is selected from one of matched, unmatched and exempted.

6. The method of claim 1, wherein the mail transmission data includes the envelope information and the header information of the email.

7. The method of claim 2, wherein the step of determining whether the email matches the spam behavior of the mail policies further includes:
(a) when the agent receives the email, verifying the mail transmission data of the email with a first mail policy to determine whether the email matches the first mail policy, if yes, step (b) will be performed, and if no, step (c) will be performed;
(b) permitting the email transmission; and
(c) tracing route of the email with a second mail policy to determine whether the email matches the second mail policy, if yes, step (b) will be performed, and if no, the email will be traced by a next mail policy till a last mail policy is used, if the email doesn't match the last mail policy, the email will be blocked by the agent.

8. The method of claim 2, wherein each mail policy further includes a plurality of rules, and the step of verifying the mail transmission data of the email with one of the mail policies further includes:
(a) verifying the mail transmission data of the email with a first rule to determine whether the email matches the first rule, if yes, step (b) will be performed, and if no, step (c) will be performed;
(b) verifying the mail transmission data of the email with second rule to determine whether the email matches the second rule, if no, step (c) will be performed, if yes, the email will be traced by a next rule till the last rule is used, and deciding whether the email matches the mail policy according to verified result of the last rule, if yes, the email will be transmitted, if no step (c) will be performed; and
(c) tracing route of the email with a next mail policy to determine whether the email matches the next mail policy, and repeating steps (a) and (b).

9. The method of claim 8, wherein the verification criterion of each rule verifying the email is selected from one of matched, unmatched and exempted, and the verification criterion is defined in the step of defining the mail policies.

10. The method of claim 1, wherein the mail policies are used to determine whether the email has an unusual behavior, the unusual behavior includes selecting at least one behavior from anonymity, counterfeit, misuse, and illegal-composed group.

11. The method of claim 10, wherein the anonymity behavior includes selecting at least one behavior from unclear header information, different send and reply mail hosts, and reply mail host being group composed of ISP host.

12. The method of claim 10, wherein counterfeit behavior includes one of that source host is an outside domain but sender address is counterfeited to an inside host, and domain name server (DNS) of the domain is incorrect.

13. The method of claim 10, wherein the misuse behavior includes that sending method is abnormal and frequently varied.

14. The method of claim 10, wherein the illegal behavior includes that reply address is a rental host.

15. The method of claim 1, wherein defining content of the mail policies can be further content of the email and attachment.

16. The method of claim 1, wherein the agent can be a mail transmission agent (MTA).

17. The method of claim 16, wherein the MTA can be a router.

18. The method of claim 1, wherein the envelope information is selected from one of groups composed of sender account, receiver account, receiver mail host address, sender mail host address, reply address, DNS, and e-postmark.

19. The method of claim 18, wherein supplier of the e-postmark is selected from at least one of groups composed of sender server, central-office server and ISP server.

20. The method of claim 1, wherein action of blocking the email is selected from one of rejecting the email and deleting the email.

21. The method of claim 20, wherein when rejecting the email, an error code and an error message is sent back.
